(19) United States
(12) Patent Application Publication
(10) Pub. No.: US 2026/0023693 A1
(43) Pub. Date: Jan. 22, 2026

(54) METHOD AND SYSTEM FOR CONNECTING A COMPUTING DEVICE TO PERIPHERALS

(71) Applicant: Nokia Solutions and Networks Oy, Espoo (FI)

(72) Inventors: Rémi VARLOOT, Massy (FR); Natalya ROZHNOVA, Massy (FR)

(21) Appl. No.: 19/266,485

(22) Filed: Jul. 11, 2025

(30) Foreign Application Priority Data
Jul. 18, 2024 (FI) 20245907

(51) Int. Cl. G06F 13/10; G06F 9/4401; H04L 12/46

(52) U.S. Cl. CPC G06F 13/10; G06F 9/4411; G06F 2213/40; H04L 12/4633

(57) ABSTRACT

A method comprises: identifying, in a set of workstations, a target workstation to be paired with a computing device connected to the network, the target workstation comprising hardware interfaces connected to peripherals, the target workstation being identified on the basis of an information representative of the localization of the computing device of the computing device; sending instructions to the computing device and to the target workstation for causing the computing device and the target workstation to establish a tunnel with each other via the network; providing, by the target workstation to the computing device through the tunnel, driving configuration data for configuring drivers adapted to be run by the computing device for driving the peripherals through the tunnel and the hardware interfaces of the target workstation.

### TECHNICAL FIELD

Various example embodiments relate generally to methods and system for connecting a computing device to peripherals and an associated computing device.

### BACKGROUND

Workspaces at business places generally provide static peripherals (e.g. mouse, keyboard, screen) at workstations (e.g. desks), which must be connected to/disconnected from computers when a user arrives at/leaves this workstation. This process can often be simplified using docking stations, but this approach is ill-suited for flex-office environments due to the diversity of computer connectivities and daily workstation changes. Moreover, these peripherals may require the installation of a dedicated driver, or to be configured in a specific manner, in order to operate correctly.

The same problem arises for meeting and conference rooms where connecting the presenter's computer to the room's equipment may be unnecessarily complicated.

The problem is even worse in public places in which various peripherals at workstations may be provided and may need to be usable by any computer.

### SUMMARY

The scope of protection is set out by the independent claims. The embodiments, examples and features, if any, described in this specification that do not fall under the scope of the protection are to be interpreted as examples useful for understanding the various embodiments or examples that fall under the scope of protection.

According to a first aspect, a method comprises: identifying, in a set of workstations, a target workstation to be paired with a computing device connected to the network, the target workstation comprising hardware interfaces connected to peripherals, the target workstation being identified on the basis of an information representative of the localization of the computing device of the computing device; sending instructions to the computing device and to the target workstation for causing the computing device and the target workstation to establish a tunnel with each other via the network; providing, by the target workstation to the computing device through the tunnel, driving configuration data for configuring drivers adapted to be run by the computing device for driving the peripherals through the tunnel and the hardware interfaces of the target workstation.

Identifying the target workstation may comprise: obtaining the information representative of the localization of the computing device; identifying, in the set of workstations, the target workstation corresponding to the information representative of the localization of the computing device.

The method may comprise: obtaining a first identifier of the computing device for which the information representative of the localization has been obtained; obtaining a second identifier of the computing device under which the computing device is identified in the network; matching the first identifier and the second identifier; determining that the identified target workstation is to be paired with the computing device based on the matching.

Driving configuration data may comprise at least one of: a driver for driving at least one of the peripherals, a download link for downloading at least one driver for driving at least one of the peripherals, at least one configuration parameter of at least one driver for driving at least one of the peripherals, at least one configuration parameter of at least one peripheral.

According to another aspect, a computing system comprises means for: identifying, in a set of workstations, a target workstation to be paired with a computing device connected to the network, the target workstation comprising hardware interfaces connected to peripherals, the target workstation being identified on the basis of an information representative of the localization of the computing device of the computing device; sending instructions to the computing device and to the target workstation for causing the computing device and the target workstation to establish a tunnel with each other via the network; providing, by the target workstation to the computing device through the tunnel, driving configuration data for configuring drivers adapted to be run by the computing device for driving the peripherals through the tunnel and the hardware interfaces of the target workstation.

The means may be adapted for performing one or more or all steps of the method according to the first aspect. The means may include at least one processor and at least one memory storing instructions that, when executed by the at least one processor, cause the apparatus to perform one or more or all steps of a method according to the first aspect. The means may include circuitry (e.g., processing circuitry) to perform one or more or all steps of a method according to the first aspect or according to any embodiment described herein.

According to another aspect, a computing system comprises at least one processor and at least one memory storing instructions that, when executed by the at least one processor, cause the computing system to perform at least: identifying, in a set of workstations, a target workstation to be paired with a computing device connected to the network, the target workstation comprising hardware interfaces connected to peripherals, the target workstation being identified on the basis of an information representative of the localization of the computing device of the computing device; sending instructions to the computing device and to the target workstation for causing the computing device and the target workstation to establish a tunnel with each other via the network; providing, by the target workstation to the computing device through the tunnel, driving configuration data for configuring drivers adapted to be run by the computing device for driving the peripherals through the tunnel and the hardware interfaces of the target workstation. The instructions, when executed by the at least one processor, may cause the apparatus to perform one or more or all steps of a method according to the first aspect or according to any embodiment described herein.

According to another aspect, a computer program comprises instructions that, when executed by a computing system, cause the computing system to perform: identifying, in a set of workstations, a target workstation to be paired with a computing device connected to the network, the target workstation comprising hardware interfaces connected to peripherals, the target workstation being identified on the basis of an information representative of the localization of the computing device of the computing device; sending instructions to the computing device and to the target workstation for causing the computing device and the target workstation to establish a tunnel with each other via the network; providing, by the target workstation to the computing device through the tunnel, driving configuration data for configuring drivers adapted to be run by the computing device for driving the peripherals through the tunnel and the hardware interfaces of the target workstation. The instructions may cause the computing system to perform one or more or all steps of a method according to the first aspect or according to any embodiment described herein.

According to another aspect, a non-transitory computer readable medium comprises computer program instructions stored thereon for causing an apparatus to perform at least the following: identifying, in a set of workstations, a target workstation to be paired with a computing device connected to the network, the target workstation comprising hardware interfaces connected to peripherals, the target workstation being identified on the basis of an information representative of the localization of the computing device of the computing device; sending instructions to the computing device and to the target workstation for causing the computing device and the target workstation to establish a tunnel with each other via the network; providing, by the target workstation to the computing device through the tunnel, driving configuration data for configuring drivers adapted to be run by the computing device for driving the peripherals through the tunnel and the hardware interfaces of the target workstation. The computer program instructions may cause the apparatus to perform one or more or all steps of a method according to the first aspect or according to any embodiment described herein.

According to a second aspect, a method for use by a computing device comprises: connecting the computer device to a network; receiving instructions for causing the computing device and a target workstation to establish a tunnel with each other via the network, the target workstation being identified in a set of workstations on the basis of an information representative of the localization of the computing device, the target workstation comprising hardware interfaces connected to peripherals; receiving, from the target workstation through the tunnel, driving configuration data for configuring drivers adapted to be run by the computing device for driving the peripherals through the tunnel and the hardware interfaces of the target workstation; configuring the computer device with the drivers based on the driving configuration data; driving the one or more of the peripherals through the tunnel using the configured drivers.

The method may comprise: providing an identifier of the computing device to identify the computing device in the network.

The driving configuration data may comprise at least one of: a driver for driving at least one of the peripherals, a download link for downloading at least one driver for driving at least one of the peripherals, at least one configuration parameter of at least one driver for driving at least one of the peripherals, at least one configuration parameter of at least one peripheral.

Configuring the drivers based on the driving configuration data may comprise at least one of: retrieving a driver for driving at least one of the peripherals, installing a driver for driving at least one of the peripherals, configuring a parameter of a driver for driving at least one of the peripheral, mounting the peripherals, configuring a parameter of a peripheral.

According to another aspect, a computing device comprises means for: connecting the computer device to a network; receiving instructions for causing the computing device and a target workstation to establish a tunnel with each other via the network, the target workstation being identified in a set of workstations on the basis of an information representative of the localization of the computing device, the target workstation comprising hardware interfaces connected to peripherals; receiving, from the target workstation through the tunnel, driving configuration data for configuring drivers adapted to be run by the computing device for driving the peripherals through the tunnel and the hardware interfaces of the target workstation; configuring the computer device with the drivers based on the driving configuration data; driving the one or more of the peripherals through the tunnel using the configured drivers.

The means may be adapted for performing one or more or all steps of the method according to the second aspect. The means may include at least one processor and at least one memory storing instructions that, when executed by the at least one processor, cause the apparatus to perform one or more or all steps of a method according to the second aspect. The means may include circuitry (e.g., processing circuitry) to perform one or more or all steps of a method according to the second aspect or according to any embodiment described herein.

According to another aspect, a computing device comprises at least one processor and at least one memory storing instructions that, when executed by the at least one processor, cause the apparatus to perform at least: connecting the computer device to a network; receiving instructions for causing the computing device and a target workstation to establish a tunnel with each other via the network, the target workstation being identified in a set of workstations on the basis of an information representative of the localization of the computing device, the target workstation comprising hardware interfaces connected to peripherals; receiving, from the target workstation through the tunnel, driving configuration data for configuring drivers adapted to be run by the computing device for driving the peripherals through the tunnel and the hardware interfaces of the target workstation; configuring the computer device with the drivers based on the driving configuration data; driving the one or more of the peripherals through the tunnel using the configured drivers. The instructions, when executed by the at least one processor, may cause the apparatus to perform one or more or all steps of a method according to the second aspect or according to any embodiment described herein.

According to another aspect, a computer program comprises instructions that, when executed by an apparatus, cause the apparatus to perform: connecting the computer device to a network; receiving instructions for causing the computing device and a target workstation to establish a tunnel with each other via the network, the target workstation being identified in a set of workstations on the basis of an information representative of the localization of the computing device, the target workstation comprising hardware interfaces connected to peripherals; receiving, from the target workstation through the tunnel, driving configuration data for configuring drivers adapted to be run by the computing device for driving the peripherals through the tunnel and the hardware interfaces of the target workstation; configuring the computer device with the drivers based on the driving configuration data; driving the one or more of the peripherals through the tunnel using the configured drivers. The instructions may cause the apparatus to perform one or more or all steps of a method according to the second aspect or according to any embodiment described herein.

According to another aspect, a non-transitory computer readable medium comprises computer program instructions stored thereon for causing an apparatus to perform at least the following: connecting the computer device to a network; receiving instructions for causing the computing device and a target workstation to establish a tunnel with each other via the network, the target workstation being identified in a set of workstations on the basis of an information representative of the localization of the computing device, the target workstation comprising hardware interfaces connected to peripherals; receiving, from the target workstation through the tunnel, driving configuration data for configuring drivers adapted to be run by the computing device for driving the peripherals through the tunnel and the hardware interfaces of the target workstation; configuring the computer device with the drivers based on the driving configuration data; driving the one or more of the peripherals through the tunnel using the configured drivers. The computer program instructions may cause the apparatus to perform one or more or all steps of a method according to the second aspect or according to any embodiment described herein.

### BRIEF DESCRIPTION OF THE DRAWINGS

Example embodiments will become more fully understood from the detailed description given herein below and the accompanying drawings, which are given by way of illustration only and thus are not limiting of this disclosure.

FIG. 1 shows an example workstation with a set of associated peripherals.

FIG. 2 shows an example computing system adapted for implementing an automated connection mechanism.

FIG. 3 shows a flowchart of a method for connecting a computing device to a workstation according to an example scenario.

FIG. 4 shows a flowchart of a method for managing connection of a computing device to a workstation according to one or more example embodiments.

FIG. 5 shows a flowchart of a method for connecting a computing device to peripherals of a workstation according to one or more example embodiments.

FIG. 6 is a block diagram illustrating an exemplary hardware structure of an apparatus according to an example.

It should be noted that these drawings are intended to illustrate various aspects of devices, methods and structures used in example embodiments described herein. The use of similar or identical reference numbers in the various drawings is intended to indicate the presence of a similar or identical element or feature.

### DETAILED DESCRIPTION

Detailed example embodiments are disclosed herein. However, specific structural and/or functional details disclosed herein are merely representative for purposes of describing example embodiments and providing a clear understanding of the underlying principles. However, these example embodiments may be practiced without these specific details. These example embodiments may be embodied in many alternate forms, with various modifications, and should not be construed as limited to only the embodiments set forth herein. In addition, the figures and descriptions may have been simplified to illustrate elements and/or aspects that are relevant for a clear understanding of the present invention, while eliminating, for purposes of clarity, many other elements that may be well known in the art or not relevant for the understanding of the invention.

In embodiments, an automated connection solution for connecting a computing device to a target workstation comprising hardware interfaces connected to peripherals applicable is provided. This automated connection solution is applicable in the context of “flex office” environments.

This automated connection solution uses a localization mechanism for identifying the target workstation connected to a set of peripherals on the basis of an information representative of the localization of the computing device. Such localization mechanism may be based on any localization and/or on proximity sensing technology (e.g., NFC or Bluetooth beacons). The localization mechanism is used for detecting which computer is located at which workstation.

The computing device may be configured to be connected through a network to an orchestration function, e.g. via a wireless network (for example, using wireless connectivity such as Wi-Fi, private LTE, 5G, etc.). The target workstation includes hardware interfaces connected to peripherals, with wired (e.g., USB, jack, HDMI, VGA, DVI, DP, USB, etc.) or wireless connections (e.g., Bluetooth®, Zigbee®, etc.). The orchestration function may send instructions to the computing device and to the target workstation for causing the computing device and the target workstation to establish a tunnel with each other via the network.

Once the computing device and target workstation are interconnected through a tunnel through the network, the computing device may use and drive peripherals connected to the workstation in a seamless manner. The computer device may for example seamlessly mount the peripherals on the computer device using driving configuration data for configuring drivers adapted to be run by the computing device for driving the peripherals through the tunnel and the hardware interfaces of the target workstation connected to peripherals.

The workstation or peripheral aggregator may be configured with dedicated software, hereafter the peripheral management function, configured to connect through the network to the orchestration function. The peripheral management function is configured to establish the tunnel through the network with a computing device and drive the peripherals of the peripheral aggregator through its hardware interface based on instructions received from the computing device through the tunnel.

The computing device may be configured with a client application to connect through the network to the orchestration function, to establish the tunnel through the network with the peripheral management function in the peripheral aggregator and drive the peripherals by sending instructions through the tunnel.

This automated connection mechanism requires no input from users to mount the peripherals. The computing device will seamlessly adapt to the workstation where the computing device is located. This automated connection mechanism provides a zero-operation seamless docking/undocking of user computers to peripherals at whichever workstation the user computers are placed.

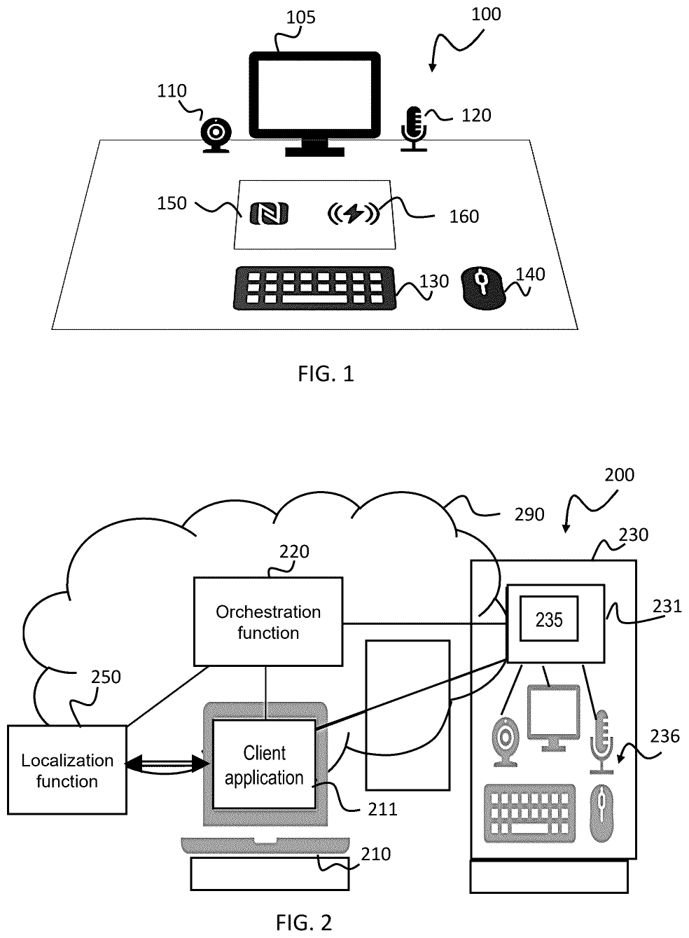

FIG. 1 shows an example workstation 100 with a set of associated peripherals.

In this example, the set of peripherals includes a display screen 105, a camera 110, a microphone 120, a keyboard 130 and a mouse 140. Any other type of peripheral may be present, like for example a printer, a scanner, a card reader, etc.

Further, in this example, there is a dedicated region 150 for placing the computing device, which includes a sensor (e.g., an NFC reader) configured for implementing a localization mechanism: here the sensor may generate an identifier of the computing device placed in the dedicated region 150.

A wireless power source 160 can be present at the workstation and be adapted for charging for example a mobile device.

In a flex-office work environment, several workstations may be available at respective locations, each workstation with their associated peripherals. When a computing device is placed upon such a workstation, these peripherals are seamlessly mounted once the location of the computing device in the flex-office work environment has been determined.

FIG. 2 shows an example computing system 200 adapted for implementing an automated connection mechanism.

The computing system 200 includes:
A localization function 250;
An orchestration function 220;
A workstation 230.

The workstation 230 includes associated peripherals and hardware interfaces (not represented) for driving the peripherals 236 through the hardware interfaces.

The localization function 250, the orchestration function 220 and the workstation 230 are operatively connected to a network 290 (e.g., a wireless network).

A computing device may be configured to connect to the network 290. The Computing device may be for example a user equipment, UE, (also referred to as user terminal or user device or terminal device or end device). The computing device may include a transceiver for wired or wireless communication, operating with or without a subscriber identification module (SIM), including, but not limited to, the following types of devices: a mobile station (MS), a mobile phone, a radio cell phone, a smartphone, a personal digital assistant (PDA), a handset, a device using a wireless modem (alarm or measurement device, etc.), a drone, a laptop and/or touch screen computer, a tablet, a phablet, a game console, a notebook, and a multimedia device, as examples. An end device may be any communicating object, e.g., a communicating object having capability to operate in an Internet of Things (IoT) network and/or having ability to transfer data over a network without requiring human-to-human or human-to-computer interaction.

The localization function 250 is adapted for implementing a localization mechanism and generating information representative of a localization of the computing device to be able to associate the computing device with a target workstation. This localization mechanism may be configured to identify which computing device, if any, is located at a given workstation. This can be done assuming that each workstation can only host a single computing device. The information representative of the localization of the computing device may be providing to the orchestration function 220 with a first identifier of the computing device obtained in response to the execution of a localization mechanism.

An information representative of the localization of the computing device may be for example a geographical localization, an identifier of a detection device (e.g., an NFC reader, a Bluetooth beacon, a sensor, etc.) associated with a given workstation, an identifier of a workstation.

The orchestration function 220 is adapted for identifying, in a set of workstations, a target workstation to be paired with a computing device connected to the network. The target workstation to be paired with a computing device may be identified on the basis of an information representative of a localization of the computing device.

The orchestration function 220 may be adapted for obtaining an information representative of the localization of the computing device from the localization function 250 and for identifying, in the set of workstations, the target workstation as the workstation that corresponds to the information representative of the localization. The orchestration function 220 may be adapted for generating pairing information indicating which workstation is to be paired with a detected computing device.

For example, if the information representative of the localization is a geographical position, the workstation that is the closest to the geographical position of the computing device may be selected as the workstation to be paired with the computing device.

For example, if the information representative of the localization is an identifier of a workstation associated with a workstation, the identified workstation is selected as the workstation to be paired with the computing device.

For example, if the information representative of the localization is an identifier of a detection device (e.g., an NFC reader, a Bluetooth beacon, a sensor, etc.) associated with a workstation, the workstation associated with the identifier of a detection device is selected as the workstation to be paired with the computing device.

For example, the NFC technology can be used, wherein a sensor (e.g., NFC reader) is built into/under the workstation where the computing device is to be placed, and the computing device carries a tag that uniquely identifies the computing device. When the sensor detects the tag, an identification of the computing device can be sent to the orchestration function together with an identification of the target workstation and/or of the sensor.

For example, Bluetooth® beacons can be used. Either the computing device includes a sensing device that senses a beacon at the workstation, or a sensor at the workstation senses a beacon signal from the computing device. For example, the computing device may regularly emits a beacon signal, and Bluetooth® sensors at the workstations may be used to detect the beacon signals and locate the computing device based on an association between the Bluetooth sensor and the workstation and/or a map locating the Bluetooth sensor and the workstation. In embodiments, combining the detection information with a map of the sensors and/or workstations enables to determine which computing device, if any, is located at which workstation.

Other detection technologies may be used. For example, sensors such as cameras or radio sensing mechanisms that are able to locate devices with sufficient precision can be used to achieve this same workstation-computing device pairing. Unlike with the previous methods, this approach does not necessarily require the computing device to be configured in any way for being localized.

The localization function 250 can either be replicated for each workstation or be used for covering multiple workstations.

The orchestration function 220 may be adapted for sending instructions to the computing device and to a target workstation for causing the computing device and the identified target workstation to establish a tunnel with each other via the network.

The orchestration function 220 may be adapted for obtaining a first identifier of the computing device. This first identifier of the computing device may be obtained in response to the execution of a localization mechanism for the computing device for obtaining the information representative of the localization.

The orchestration function 220 may be adapted for obtaining a second identifier of the computing device under which the computing device is identified in the network. This second identifier may be obtained in response to a connection of the computing device to the network 290.

The orchestration function 220 may be adapted for matching the first identifier and the second identifier and determining that the target workstation is to be paired with the computing device based on the matching.

The workstation 230, e.g., the peripheral aggregator 231, may include a peripheral management function 235 for providing, to a computing device through a tunnel, driving configuration data for configuring drivers adapted to be run by the computing device for driving the peripherals through the tunnel and the hardware interfaces of the target workstation.

In order to be seamlessly mounted onto a computing device, peripherals 236 may be pre-connected to a fixed intermediary hardware component of the workstation, this fixed intermediary hardware component being referred to herein as the peripheral aggregator 231. The peripheral aggregator 231 may be configured for supporting connectivity protocols used for peripherals 236, like for example:
For wireless connectivity: Bluetooth, ZigBee, Wi-Fi, etc.
For wired connectivity: VGA, DVI, HDMI, DP, USB, audio/microphone jack, etc.

Unlike typical docking stations, the peripheral aggregator 231 can be an active component implementing the peripheral management function 235 and serving as an attachment point for both wired and wireless connections of peripherals 236.

The peripheral management function 235 may be integrated into a hardware device serving as peripheral aggregator 231 to which the peripherals 236 of one or more workstations 230 can be connected or may be integrated into another hardware device.

A given peripheral aggregator 231 may be used for driving peripherals of a single workstation 230 or for multiple workstations, e.g. for adjacent/contiguous workstations. A peripheral management function 235 run by the peripheral aggregator 231 is configured to define which peripheral(s) is (are) associated with which workstation. The peripheral management function 235 is configured to establish a tunnel for each computing device requesting use of peripherals of a given workstation (e.g., a tunnel per workstation).

The computing devices may connect to the network 290 through any type of connection: e.g., Wi-Fi, private LTE/5G, etc. Once connected, a client application 211 in the computing device may be configured to connect to the orchestration function via this network. The client application 211 may be connected directly to the orchestration function, or via a dedicated application server that serves as an application proxy for the orchestration function 220.

The client application 211 may maintain the connection with the orchestration function 220 as long as the computing device 210 remains attached to the network 290, so that the client application 211 can receive instructions from the orchestration function 220, e.g. to set up new tunnels when located at a new workstation and/or to participate to a security mechanism required for accessing to the network 290.

When a computing device 210 arrives at a workstation, the client application 211 may receive instructions from the orchestration function 220 for setting up a tunnel to the peripheral management function 235 of the peripheral aggregator 231 of the target workstation to be used, either via a direct connection, or via a rendezvous server.

When a computing device 210 is to be paired with a given workstation 230, the peripheral management function 235 associated with the peripheral aggregator 231 of this workstation receives instructions from the orchestration function 220 to set up a tunnel with the computing device 210. The tunnel may be established directly between the peripheral management function 235 associated with the peripheral aggregator 231 of this workstation and a client application 211 in the computing device or through one or more intermediate entities (e.g., through a rendezvous server).

Upon establishing this tunnel, the peripheral management function 235 may advertise its peripherals to the client application 211. The peripheral management function 235 may provide driving configuration data (including any required driver and/or configuration parameters) for driving the peripherals through the tunnel.

The driving configuration data may include: at least one of: a driver for driving at least one of the peripherals, a download link for downloading at least one driver for driving at least one of the peripherals, at least one configuration parameter of at least one driver for driving at least one of the peripherals, at least one configuration parameter of at least one peripheral. For example, the peripheral management function 235 can either directly provide the drivers or provide driving configuration data for retrieving the drivers.

The client application 211 may receive from the peripheral management function 235 advertisements for the peripherals connected at the workstation, alongside driving configuration data. The client application 211 may be configured for retrieving and installing the required drivers, mounting the peripherals, and configuring the peripherals.

Once drivers are installed at the computing device and their configuration is complete, the peripheral management function 235 may stream driving data between its peripherals and the client application 211. Once a peripheral is mounted by the computing device 210, the client application 211 may continuously receive driving data for the driver and transmit driving data for the peripherals through the tunnel.

Inbound driving data may be decapsulated, then be provided to the corresponding driver so that the considered peripheral appears to be directly connected to the computing device. Conversely, driving data emitted by the driver may be encapsulated and sent through the tunnel, to be transmitted to the considered peripheral by the peripheral management function 235. For example, a Bluetooth connected keyboard should appear as being connected locally to the computing device: when the client application 211 receives an encapsulated Bluetooth packet through the tunnel, the client application 211 provides the packet to the installed driver as if the packet were from a locally Bluetooth connected keyboard, and similarly, any Bluetooth packet emitted by the driver is encapsulated and transmitted through the tunnel to the Bluetooth connected keyboard.

Optionally, any of the peripheral management function 235, the client application 211, (and/or the rendezvous server) can include a protocol translation mechanism, allowing peripherals connected with one technology to the peripheral management function 235 to be mounted using another technology on the computing device, e.g. a Bluetooth keyboard mounted as a USB keyboard by translating Bluetooth packets to corresponding USB packets and vice versa.

The orchestration function 220 may be configured for ensuring that the correct pairings are established between peripheral management functions 235 and client applications 211. For example, when a computing device's localization or a workstation's occupation is updated by the localization function, the orchestration function 220 checks if a new pairing should be instantiated, or an existing pairing should be cancelled. The orchestration function 220 may be configured to send instructions to the concerned peripheral management function 235 and client application 211 (as well as to the rendezvous server, if one is in use) to create a tunnel or respectively close the tunnel.

The orchestration function 220 may communicate with the client application, peripheral management function 235 and the localization function 250 through the network 290 or through any sub-network, e.g. a secured part of the network 290.

A client application 211 may connect directly to the orchestration function 220, or through to a dedicated application server that serves as an application proxy for the orchestration function 220.

A tunnel can either be established directly between the client application 211 and the peripheral management function 235, or through an intermediate entity (e.g., used as a rendezvous server. The intermediate entity may be the orchestration function itself, or the dedicated application server if one is in use. If several rendezvous servers are available, the orchestration function 220 may be configured to determine which one to use.

A security mechanism may be used to ensure that a computing device not situated at a given workstation cannot mount peripherals 236 connected to that peripheral aggregator 231 of this workstation. This can be implemented by having the orchestration function 220 instruct the peripheral management function 235 (or the tunnel rendezvous server) as to what tunnels to accept from a computing device.

An authorization mechanism may be used by which the orchestration function 220 checks (e.g., with an internal or external ACL) if a given computing device is authorized or not to mount the peripherals at a given workstation. This authorization mechanism may include rules for allowing computing devices to mount only part of the available peripherals (for example, only peripherals in a given category or only pre-identified peripherals), in which case the peripheral management function 235 may be instructed by the orchestration function 220 to only advertise these peripherals.

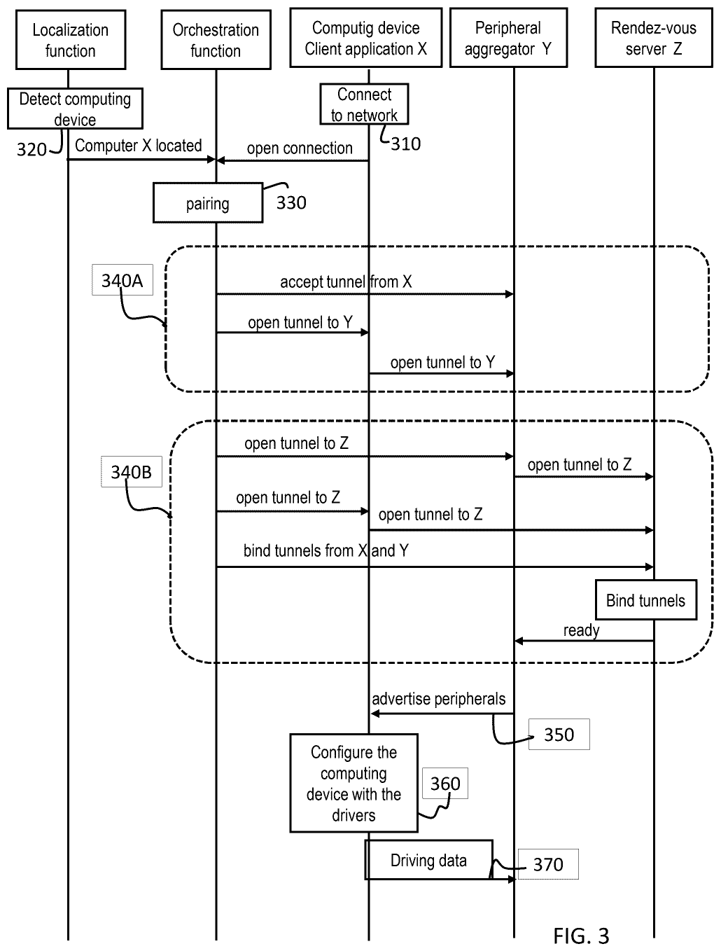

FIG. 3 shows a flowchart of a method for connecting a computing device 210 to a workstation 230 according to an example.

This scenario involves an orchestration function 220, a peripheral aggregator 231 (e.g., configured with a peripheral management function 235) and a localization function 250. These entities may be implemented according to any embodiments disclosed herein, for example by reference to FIGS. 1 and/or 2.

It is assumed that, when a user arrives with its computing device 210:
the orchestration function 220, the peripheral aggregator 231 configured with a peripheral management function 235 and the localization function 250 are all running and interconnected through a network 290;
the peripherals 236 are already attached to the peripheral aggregator 231 of the workstation;
the computing device 210 is already configured with the client application 211; the client application may be running in the background on the computing device or be automatically launched when the computing device is started.

In step 310, the computing device 210 connects to the network. This triggers the client application 211 to connect to the orchestration function 230.

In step 320, the localization function 250 detects the presence of the computing device at a given workstation 230. An information representative of the localization of the computing device is generated and sent to the orchestration function.

Steps 310 and 320 may be performed in any order, depending on whether the computing device is turned on and connects to the enterprise network before or after being placed at its workstation.

In step 330, the orchestration function 220 may be adapted for obtaining a first identifier of the computing device. This first identifier of the computing device may be obtained in response to the execution of the localization mechanism (step 320) for the computing device for obtaining the information representative of the localization.

In step 330, the orchestration function 220 may be adapted for obtaining a second identifier of the computing device under which the computing device is identified in the network. This second identifier may be obtained in response to a connection of the computing device to the network 290.

In step 330, the orchestration function 220 may be adapted for matching the first identifier and the second identifier and determining that the target workstation is to be paired with the computing device based on the matching.

In step 330, the orchestration function 220 may be adapted for generating pairing information indicating which workstation is to be paired with a detected computing device.

In step 340, once steps 310 to 320 have been performed, the orchestration function 220 sends instructions in order to create a tunnel between the client application 211 in the computing device 210 and the peripheral aggregator 231.

Creating the tunnel occurs in one of two ways (step 340A or step 340B), depending on whether or not the tunnel is established through a rendezvous server:
without a rendezvous server (step 340A): the orchestration function instructs the client application to open a tunnel to the corresponding peripheral aggregator 231 and instructs the peripheral aggregator 231 that it should accept this connection.
with a rendezvous server (step 340B): the orchestration function instructs both the client application and the peripheral aggregator 231 to open tunnels to the rendezvous server, while at the same time informing the rendezvous server that the rendezvous server should accept these connections from the peripheral aggregator 231 and the client application and then stitch the two tunnels together.

In step 350, the peripheral aggregator 231 may advertise its peripherals to the client application 211.

In step 360, the client application 211 may configure the computing device 210 with the drivers, e.g., by installing the corresponding drivers, mounting the peripherals and configuring the drivers and/or peripherals.

In step 370, the driving data (from the peripheral for the driver and vice-versa) are encapsulated and streamed back and forth through the tunnel between the peripherals and the driver mounted in the computing device.

When the computing device is disconnected from the network or switch off, a computing device departure process may be implemented. The departure process may include: unmounting the peripherals and closing the tunnel.

In case security or authorizations are enforced, the peripheral aggregator (or peripheral management function) and/or rendezvous server may be informed that the computing device is disconnected and opening tunnels for this workspace and that prior authorization for this computing device is revoked.

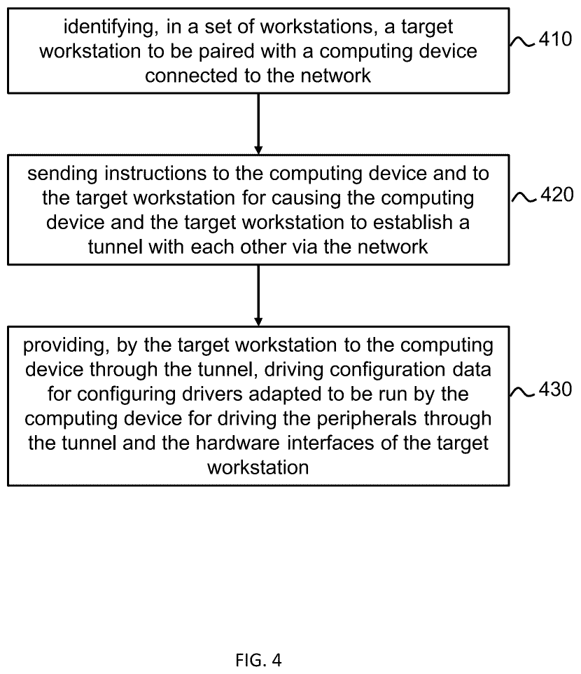

FIG. 4 shows a flowchart of a method for managing connection of a computing device to a workstation according to one or more example embodiments.

The steps of the method may be implemented by a computing system according to any example described herein. Aspects, steps and functions described by reference to FIGS. 1-3 may be combined with the aspects, steps and functions described by reference to FIG. 4.

While the steps are described in a sequential manner, the person skilled in the art will appreciate that some steps may be omitted, combined, performed in different order and/or in parallel.

In step 410, a target workstation to be paired with a computing device connected to the network is identified in a set of workstations. The target workstation comprises hardware interfaces connected to peripherals.

The target workstation may be identified on the basis of an information representative of the localization of the computing device of the computing device.

An information representative of the localization of the computing device of the computing device may be for example a geographical localization, an identifier of a detection device, an identifier of a workstation.

Identifying the target workstation to be paired may comprise:
obtaining the information representative of the localization of the computing device;
identifying, in the set of workstations, the target workstation corresponding to the information representative of the localization of the computing device.

Identifying the target workstation to be paired may comprise:
obtaining a first identifier of the computing device for which the information representative of the localization has been obtained;
obtaining a second identifier of the computing device under which the computing device is identified in the network;
matching the first identifier and the second identifier;
determining that the target workstation is to be paired with the computing device based on the matching.

In step 420, the instructions are sent (e.g., by an orchestration function) to the computing device and to the target workstation for causing the computing device and the target workstation to establish a tunnel with each other via the network;

In step 430, the target workstation provides to the computing device through the tunnel, driving configuration data for configuring drivers adapted to be run by the computing device for driving the peripherals through the tunnel and the hardware interfaces of the target workstation.

The driving configuration data may comprise at least one of: a driver for driving at least one of the peripherals, a download link for downloading at least one driver for driving at least one of the peripherals, at least one configuration parameter of at least one driver for driving at least one of the peripherals, at least one configuration parameter of at least one peripheral.

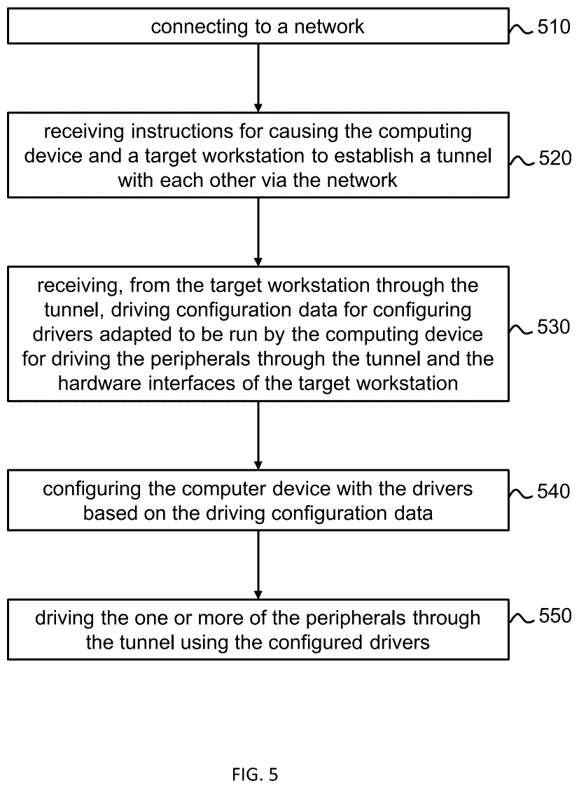

FIG. 5 shows a flowchart of a method for connecting a computing device to peripherals of a workstation according to one or more example embodiments.

The steps of the method may be implemented by a computing device according to any example described herein. Aspects, steps and functions described by reference to FIGS. 1-3 may be combined with the aspects, steps and functions described by reference to FIG. 5.

While the steps are described in a sequential manner, the person skilled in the art will appreciate that some steps may be omitted, combined, performed in different order and/or in parallel.

In step 510, the computing device connects to a network (e.g., a wireless network). Once the computing device is connected, the computing device may communicate with an orchestration function as described herein and then establish a tunnel as described herein.

The computing device may be adapted for providing (e.g., to an orchestration function) a second identifier of the computing device to identify the computing device in the network. The second identifier may be matched with a first identifier of the computing device for which the information representative of the localization has been obtained.

In step 520, the computing device receives instructions for causing the computing device and a target workstation to establish a tunnel with each other via the network, the target workstation being identified in a set of workstations on the basis of a localization of the computing device and comprising hardware interfaces connected to peripherals;

In step 530, the computing device receives, from the target workstation through the tunnel, driving configuration data for configuring drivers adapted to be run by the computing device for driving the peripherals through the tunnel and the hardware interfaces of the target workstation;

The driving configuration data may comprise at least one of: a driver for driving at least one of the peripherals, a download link for downloading at least one driver for driving at least one of the peripherals, at least one configuration parameter of at least one driver for driving at least one of the peripherals, at least one configuration parameter of at least one peripheral.

In step 540, the computing device is configured with the drivers based on the driving configuration data.

Configuring the drivers based on the driving configuration data may comprise at least one of: retrieving a driver for driving at least one of the peripherals, installing a driver for driving at least one of the peripherals, configuring a parameter of a driver for driving at least one of the peripheral, mounting the peripherals, configuring a parameter of s peripheral, etc.

In step 550, the computing device drives the one or more of the peripherals through the tunnel using the configured drivers.

The computing device may be adapted for being submitted to a localization mechanism adapted to generate the information representative localization of the computing device. A first identifier of the computing device may be obtained when performing the localization mechanism.

It should be appreciated by those skilled in the art that any functions, engines, block diagrams, flow diagrams, state transition diagrams, flowchart and/or data structures described herein represent conceptual views of illustrative circuitry embodying the principles of the invention. Similarly, it will be appreciated that any flow charts, flow diagrams, state transition diagrams, pseudo code, and the like represent various processes.

Although steps of a method or process may be described in a sequential manner, some of the steps may be performed in parallel, concurrently or simultaneously. Also some steps may be omitted, combined or performed in different order.

One or more or all operation(s) of a method, process, function, engine, block, step described herein may be implemented in hardware, software, firmware, middleware, microcode, or any suitable combination thereof.

When implemented in software, firmware, middleware or microcode, instructions to perform the considered operation(s) may be stored in a computer readable medium that may be or not included in a computing device (or respectively a computing system) configured to execute the instructions. The instructions may be transmitted over the computer-readable medium and be loaded onto the computing device (or respectively computing system). The instructions are configured to cause the computing device (or respectively computing system) to perform the considered operation(s). For example, as mentioned above, at least one memory may include or store instructions, the at least one memory and the instructions may be configured to, with at least one processor, cause the computing device (or respectively computing system) to perform the considered operation(s).

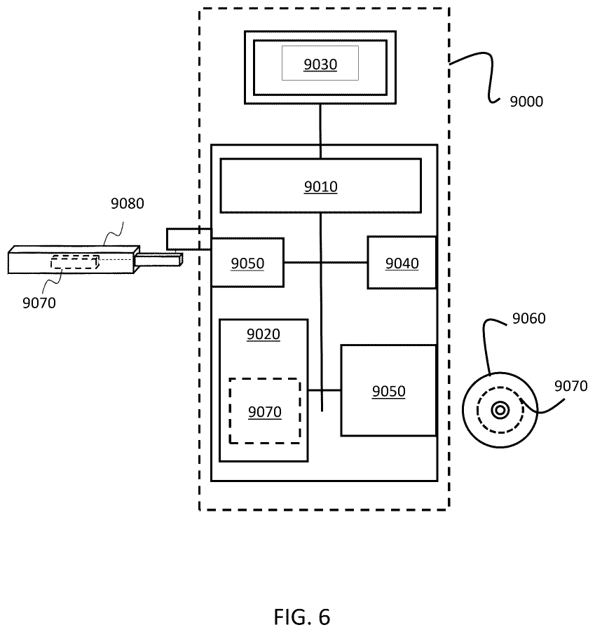

FIG. 6 illustrates an example embodiment of an apparatus 9000, as an example of computing device. The apparatus 9000 may be configured to perform one or more functions of computing device disclosed herein. The apparatus 9000 may be configured to perform one or more or all steps of a method disclosed herein.

As represented schematically, the apparatus 9000 may include at least one processor 9010 and at least one memory 9020. The apparatus 9000 may include one or more communication interfaces 9040 (e.g., network interfaces for access to a wired/wireless network, including Ethernet interface, WI-FI interface, etc.) connected to the processor and configured to communicate via wired/non wired communication link(s). The apparatus 9000 may include user interfaces 9030 (e.g., keyboard, mouse, display screen, etc.) connected with the processor. The apparatus 9000 may further include one or more media drives 9050 for reading a computer-readable storage medium (e.g., digital storage disc 9060 (CD-ROM, DVD, Blue Ray, etc.), USB key 9080, etc.). The processor 9010 is connected to each of the other components 9020, 9030, 9040, 9050 in order to control operation thereof.

The memory 9020 may be or include a random-access memory (RAM), cache memory, non-volatile memory, backup memory (e.g., programmable or flash memories), read-only memory (ROM), a hard disk drive (HDD), a solid-state drive (SSD) or any combination thereof. The ROM of the memory 9020 may be configured to store, amongst other things, an operating system of the apparatus 9000 and/or one or more computer program code of one or more software applications. The RAM of the memory 9020 may be used by the processor 9010 for the temporary storage of data.

The processor 9010 may be configured to store, read, load, execute and/or otherwise process instructions 9070 stored in a computer-readable storage medium 9060, 9080 and/or in the memory 9020 such that, when the instructions are executed by the processor, causes the apparatus 9000 to perform one or more or all steps of a method described herein for the concerned apparatus 9000.

The instructions may correspond to program instructions or computer program code. The instructions may include one or more code segments. A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

When provided by a processor, the functions may be provided by a single dedicated processor, by a single shared processor, or by a plurality of individual processors, some of which may be shared. The term “processor” should not be construed to refer exclusively to hardware capable of executing software and may implicitly include one or more processing circuits, whether programmable or not. A processor or likewise a processing circuit may correspond to a digital signal processor (DSP), a network processor, an application specific integrated circuit (ASIC), a field programmable gate array (FPGA), a System-on-Chips (SoC), a Central Processing Unit (CPU), an arithmetic logic unit (ALU), a programmable logic unit (PLU), a processing core, a programmable logic, a microprocessor, a controller, a microcontroller, a microcomputer, a quantum processor, any device capable of responding to and/or executing instructions in a defined manner and/or according to a defined logic.

A computer readable medium or computer readable storage medium may be any tangible storage medium suitable for storing instructions readable by a computer or a processor. A computer readable medium may be more generally any storage medium capable of storing and/or containing and/or carrying instructions and/or data. The computer readable medium may be a non-transitory computer readable medium. The term “non-transitory”, as used herein, is a limitation of the medium itself (i.e., tangible, not a signal) as opposed to a limitation on data storage persistency (e.g., RAM vs. ROM).

A computer-readable medium may be a portable or fixed storage medium. A computer readable medium may include one or more storage device like a permanent mass storage device, magnetic storage medium, optical storage medium, digital storage disc (CD-ROM, DVD, Blue Ray, etc.), USB key or dongle or peripheral, a memory suitable for storing instructions readable by a computer or a processor.

A memory suitable for storing instructions readable by a computer or a processor may be for example: read only memory (ROM), a permanent mass storage device such as a disk drive, a hard disk drive (HDD), a solid-state drive (SSD), a memory card, a core memory, a flash memory, or any combination thereof.

In the present description, the wording “means configured to perform one or more functions” or “means for performing one or more functions” may correspond to one or more functional blocks comprising circuitry that is adapted for performing or configured to perform the concerned function(s). The block may perform itself this function or may cooperate and/or communicate with other one or more blocks to perform this function. The “means” may correspond to or be implemented as “one or more modules”, “one or more devices”, “one or more units”, etc.

The means may include at least one processor and at least one memory including at least one memory storing instructions that, when executed by the at least one processor, cause an apparatus to perform the considered function(s). The means may include circuitry (e.g., processing circuitry) configured to perform the considered function(s).

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together; and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, an integrated circuit for a network element or network node or any other computing device or network device.

The term circuitry may cover digital signal processor (DSP) hardware, network processor, application specific integrated circuit (ASIC), field programmable gate array (FPGA), etc. The circuitry may be or include, for example, hardware, programmable logic, a programmable processor that executes software or firmware, and/or any combination thereof (e.g., a processor, control unit/entity, controller) to execute instructions or software and control transmission and receptions of signals, and a memory to store data and/or instructions.

The circuitry may also make decisions or determinations, generate frames, packets or messages for transmission, decode received frames or messages for further processing, and other tasks or functions described herein. The circuitry may control transmission of signals or messages over a radio network, and may control the reception of signals or messages, etc., via one or more communication networks.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, when the term “and/or” is used in a list of items, it implies that the list may include any and all combinations of one or more of the associated listed items.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

While aspects of the present disclosure have been particularly shown and described with reference to the embodiments above, it will be understood by those skilled in the art that various additional embodiments may be contemplated by the modification of the disclosed devices, systems and methods without departing from the scope of what is disclosed. Such embodiments should be understood to fall within the scope of the present disclosure as determined based upon the claims and any equivalents thereof.

### LIST OF MAIN ABBREVIATIONS

ACL Access-Control List
DP DisplayPort
DV Digital Visual Interface
HDMI High-Definition Multimedia Interface
LTE Long-Term Evolution
NFC Near Field Communication
URL Uniform Resource Locator
USB Universal Serial Bus
VGA Video Graphics Array

1. A method comprising:
identifying, in a set of workstations, a target workstation to be paired with a computing device connected to a network, the target workstation comprising hardware interfaces connected to peripherals, the target workstation being identified on the basis of information representative of the localization of the computing device;
sending instructions to the computing device and to the target workstation for causing the computing device and the target workstation to establish a tunnel with each other via the network;
providing, by the target workstation to the computing device through the tunnel, driving configuration data for configuring drivers adapted to be run by the computing device for driving the peripherals through the tunnel and the hardware interfaces of the target workstation.

2. The method of claim 1, wherein identifying the target workstation comprises:
obtaining the information representative of the localization of the computing device;
identifying, in the set of workstations, the target workstation corresponding to the information representative of the localization of the computing device.

3. The method of claim 1, comprising:
obtaining a first identifier of the computing device for which the information representative of the localization has been obtained;
obtaining a second identifier of the computing device under which the computing device is identified in the network;
matching the first identifier and the second identifier;
determining that the identified target workstation is to be paired with the computing device based on the matching.

4. The method of claim 1, wherein the driving configuration data comprises at least one of: a driver for driving at least one of the peripherals, a download link for downloading at least one driver for driving at least one of the peripherals, at least one configuration parameter of at least one driver for driving at least one of the peripherals, at least one configuration parameter of at least one peripheral.

5. A method for use by a computing device, the method comprising:
connecting the computing device to a network;
receiving instructions for causing the computing device and a target workstation to establish a tunnel with each other via the network, the target workstation being identified in a set of workstations on the basis of information representative of the localization of the computing device, the target workstation comprising hardware interfaces connected to peripherals;
receiving, from the target workstation through the tunnel, driving configuration data for configuring drivers adapted to be run by the computing device for driving the peripherals through the tunnel and the hardware interfaces of the target workstation;
configuring the computer device with the drivers based on the driving configuration data;
driving one or more of the peripherals through the tunnel using the configured drivers.

6. The method of claim 5, comprising:
providing an identifier of the computing device to identify the computing device in the network.

7. The method of claim 5, wherein the driving configuration data comprises at least one of: a driver for driving at least one of the peripherals, a download link for downloading at least one driver for driving at least one of the peripherals, at least one configuration parameter of at least one driver for driving at least one of the peripherals, at least one configuration parameter of at least one peripheral.

8. The method of claim 5, wherein configuring the drivers based on the driving configuration data comprises at least one of: retrieving a driver for driving at least one of the peripherals, installing a driver for driving at least one of the peripherals, configuring a parameter of a driver for driving at least one of the peripherals, mounting the peripherals, configuring a parameter of a peripheral.

9. A computing device comprising at least one processor and at least one memory storing instructions that, when executed by the at least one processor, cause the computing device to perform at least:
connecting to a network;
receiving instructions for causing the computing device and a target workstation to establish a tunnel with each other via the network, the target workstation being identified in a set of workstations on the basis of information representative of the localization of the computing device, the target workstation comprising hardware interfaces connected to peripherals;
receiving, from the target workstation through the tunnel, driving configuration data for configuring drivers adapted to be run by the computing device for driving the peripherals through the tunnel and the hardware interfaces of the target workstation;
configuring the drivers based on the driving configuration data;
driving one or more of the peripherals through the tunnel using the configured drivers.

10. The computing device according to claim 9, wherein the at least one processor and the at least one memory storing instructions that, when executed by the at least one processor, cause the computing device to perform at least
providing an identifier of the computing device to identify the computing device in the network.

11. The computing device according to claim 9, wherein the driving configuration data comprises at least one of: a driver for driving at least one of the peripherals, a download link for downloading at least one driver for driving at least one of the peripherals, at least one configuration parameter of at least one driver for driving at least one of the peripherals, at least one configuration parameter of at least one peripheral.

12. The computing device according to claim 9, wherein configuring the drivers based on the driving configuration data comprises at least one of: retrieving a driver for driving at least one of the peripherals, installing a driver for driving at least one of the peripherals, configuring a parameter of a driver for driving at least one of the peripherals, mounting the peripherals, configuring a parameter of a peripheral.
